(19) United States
(12) Patent Application Publication
(10) Pub. No.: US 2014/0370174 A1
(43) Pub. Date: Dec. 18, 2014

(54) METHOD FOR MANUFACTURING RETORT RICE, AND RETORT RICE

(71) Applicant: Mariko Kanemoto, Mihara-shi (JP)

(72) Inventors: Takeshi Fukumori, Tokyo (JP); Shigeharu Kanemoto, Hiroshima (JP); Keishi Wakabayashi, Tokyo (JP); Fuminori Harada, Hiroshima (JP); Toshinori Kawamoto, Hiroshima (JP)

(21) Appl. No.: 13/878,161

(22) PCT Filed: Oct. 5, 2010
(86) PCT No.: PCT/JP2010/005975

§ 371 Date: Jun. 19, 2014

(51) Int. Cl. A23L 1/182; A23L 3/02

(52) U.S. Cl. CPC A23L 1/1826; A23L 3/022; A23V 2002/00
USPC 426/412

(57) ABSTRACT

A method for manufacturing retort-pouch rice is described. The method makes it possible to implement a production process using an assembly line and increases production efficiency by reducing the amount of time taken by a preprocess prior to a retort sterilization process. The method is characterized in that: uncooked rice is treated by pressurized heated steam, forming a thin gelatinized layer in the surface layer of each rice grain and rendering the center of each grain porous; without being cooled, the rice grains are immediately sealed inside a container together with a prescribed amount of rice-cooking liquid; the rice grains are immersed in and made to absorb the rice-cooking liquid; the water-absorption state of the rice grains and the amount of rice-cooking liquid in the container are adjusted; and retort sterilization is performed.

### TECHNICAL FIELD

The present invention relates to a method for manufacturing retort rice that employs a heat-resistant container such as a retort pouch or the like, and to retort rice manufactured by the method.

### BACKGROUND ART

Over the past several years, various kinds of retort rice that can be consumed after simple immersion in boiling water or heating in a microwave have appeared on the market, and numerous methods for manufacturing retort rice have been proposed as well (for example, see Patent Documents 1 to 5).

Patent Document 1 discloses a method for manufacturing retort rice by a heating/temperature elevation step in which a sealed pouch containing air in an amount equal to 25 to 40% of the total volume of the uncooked rice and an aqueous solution for cooking is elevated to a predetermined temperature while undergoing half-rotations at a rotation speed of 1 to 15 rpm every one to two minutes at a product temperature of 70 to 90° C., a heat sterilization step in which the product is held at or above the predetermined temperature, and a cooling step, are performed in succession.

This method for manufacturing retort rice allows for uniform distribution of moisture within the pouch during cooking, prevents the rice thereby obtained from losing shape and becoming doughy, and makes it possible for the rice to be easily and uniformly dispersed within the pouch.

Patent Document 2 discloses a method for manufacturing treated rice, in which white rice is washed in room-temperature water, then, without soaking the white rice in water, normal-temperature water is flushed around the grains and drained while maintaining the initial water content of approximately 10 to 24%, then cooking water is added in a 0.7- to 1.5-fold amount to the rice immediately prior to cooking, followed by cooking at normal pressure; once cooked, the product is packed in sterile equipment into heat-resistant containers having gas-barrier properties, completely sealed therein, and subjected to a retort process.

This method makes it possible to readily and inexpensively manufacture treated rice containing grains that retain their original shape while having an appropriate bite-response on being chewed, without any stickiness from outflowing starch, mushiness, clouding of the water or seasoning liquid, or the texture being too soft or gruel-like; the treated rice being inexpensive and storable for extended periods while having consistently excellent taste and mouthfeel.

Patent Document 3 discloses a method for manufacturing retort porridge by subjecting uncooked rice to a steaming process for 10 to 240 seconds at 100 to 250° C. to form a 0.1 to 1.5 mm gelatinous layer on the surface of the rice, followed by cooling and retorting.

According to this method, the incidence of cracked rice or mushy rice can be minimized; undesirable odors such as rice bran odor, old rice odor, and the like can be minimized; and retort porridge of improved quality can be manufactured.

Patent Document 4 discloses a method for manufacturing retort rice, in which uncooked rice, without undergoing any pre-processing such as washing or soaking, is subjected to partial gelatinous conversion of the surfaces by a method such as steaming, then packed into containers and retort sterilized.

According to this method, western-style retort rice of a texture having minimal stickiness can be manufactured.

Patent Document 5 discloses a method for manufacturing a rice retort product, in which, subsequent to washing, the wetted rice is drained and initially heated, and thereafter the treated rice, together with an appropriate amount of water, is packed into containers and sealed therein, flipped and made to absorb water, and subjected to retort cooking and sterilization.

According to this method, a rice retort product of uniform product quality, excellent taste and texture, and good storability can be manufactured.

However, the methods disclosed in Patent Documents 1 to 3 and 5 necessitate time for the washing and absorption processes in the preliminary steps leading to retort sterilization, which is a problem in terms of production efficiency. The methods disclosed in Patent Documents 3 and 4 require furnishing a step to cool the rice subsequent to the steaming process, which is a problem in terms of production efficiency.

On the other hand, the manufacturing method disclosed in Patent Document 2 and the method disclosed in Patent Document 3 teach packing of sticky cooked rice, or rice that has been soaked in water, respectively, into containers or pouches; however, during packing into the containers or pouches, it is necessary to weigh rice that has aggregated, and this presents a problem for implementing the production steps on an assembly line. Moreover, the method disclosed in Patent Document 5 teaches subjecting the rice having passed through the washing step or the like to absorption/swelling to contain 15 to 40% water, and to heat treatment, followed by packing into containers; however, because the treated rice tends to aggregate, weighing during packing into the containers is inconsistent, which presents a problem for implementing the production steps on an assembly line.

### CITATION LIST

### Patent Literature

Patent Document 1: Japanese Patent No. 3250953

Patent Document 2: Japanese Patent No. 4300161

Patent Document 3: Japanese Laid-Open Patent Application 2006-180737

Patent Document 4: Japanese Laid-Open Patent Application 6-303926

Patent Document 5: Japanese Patent Kokoku Publication 62-5574

### SUMMARY OF INVENTION

### Technical Problem

Accordingly, an object of the present invention is to offer a method for manufacturing retort rice, whereby pretreatment time leading up to the retort sterilization process can be shortened and production efficiency improved, and whereby the production steps can be implemented on an assembly line.

Another object of the present invention is to offer retort rice of the proper texture, according to the type of rice.

### Solution to Problem

In order to achieve the aforementioned object, the method for manufacturing retort rice of the present invention comprises the steps of:

forming a thin gelatinized layer on the surface layer of individual rice grains and making the center of each of the grains porous by treating uncooked rice with pressurized heated steam;

immediately packing and sealing the rice grains inside a container together with a predetermined amount of a rice-cooking liquid without passing the grains through a cooling step; adjusting the state of absorption of the rice grains and the amount of rice-cooking liquid in the container by immersing the rice grains in the rice-cooking liquid and allowing the grains to absorb the liquid; and performing retort sterilization.

Herein, the rice-cooking liquid in the present invention includes at least the liquid from solids such as ingredients that are packed into the container together with the rice grains; liquids such as water, seasoning liquid, or the like.

In the method for manufacturing retort rice of the present invention, preferably, the uncooked rice having a water content of from 9% to 13% is treated with pressurized heated steam for 1 to 5 minutes at a pressure of 0.07 to 0.38 MPa and a temperature of 115 to 150° C., and a gelatinized layer of 0.3 to 0.8 mm is formed on the surface layer of each of the rice grains.

In the method for manufacturing retort rice of the present invention, preferably, the sealed container is subjected to immersion and flipping/absorption for 20 to 40 minutes.

In the method for manufacturing retort rice of the present invention, preferably, during the immersion and absorption, the container is flipped from several times to between 10 and 20 times, and the container is warmed by hot air at 60 to 80° C.

In the method for manufacturing retort rice of the present invention, preferably, the container is a pouch; and headspace of from 45 to 70% is ensured so that the contents can move and flip inside the pouch during the immersion and absorption.

The retort rice of the present invention produced by a process comprising the steps of:

forming a thin gelatinized layer on the surface layer of individual rice grains and making the center of each of the grains porous by treating uncooked rice with pressurized heated steam;

immediately packing and sealing the rice grains inside a container together with a predetermined amount of a rice-cooking liquid without cooling the grains; and adjusting the depth of gelatinization and the degree of wetness of the rice cooked by retort sterilization according to the state of absorption of the rice grains and the amount of rice-cooking liquid in the container by immersing the rice grains in the rice-cooking liquid and allowing the grains to absorb the liquid.

### Advantageous Effects of Invention

According to the method for manufacturing retort rice of the present invention, uncooked rice is treated with pressurized heated steam, forming a thin gelatinized layer on the surface layer of each rice grain as well as rendering the center of the grains porous, and therefore the rate of absorption and permeation of the rice-cooking liquid into the rice grains is faster once the grains have been packed and sealed in the container, and the amount of absorbed water is increased. Moreover, the uncooked rice having no higher than a normal water content such that the center of each grain is rendered porous through treatment with pressurized heated steam is treated with pressurized heated steam; therefore, the rice grains do not aggregate after treatment, and are easily measured during packing into the container. As a result, the pretreatment time leading up to the retort sterilization process can be shortened and production efficiency improved, and implementation of the production steps on an assembly line is possible as well.

Additionally, according to the method for manufacturing retort rice of the present invention, because of the increased amount of absorption by the grains subsequent to treatment with pressurized heated steam, the texture of the cooked rice can be freely adjusted according to type, by adjusting the amount of rice-cooking liquid packed into the container together with the rice grains, the immersion and absorption times subsequent to packing and sealing in the container, and other parameters.

In particular, according to the method for manufacturing retort rice of the present invention, uncooked rice having no more than a normal water content so as to be rendered porous in the center of each grain through treatment with pressurized heated steam can absorb water into the center of each grain, whereby even in the case of a long-grain type starting material rice having low water content, which is a type used in the past primarily for the manufacture of rice of a texture having minimal stickiness, rice having more stickiness as compared with the case of conventional long-grain type can be manufactured.

In the method for manufacturing retort rice of the present invention, the thickness of the gelatinized layer formed on the surface layer of each rice grain, as well the state of porosity observed in the center of each grain, can be adjusted through appropriate setting of the pressure, temperature, and treatment time during treatment of the uncooked rice by pressurized heated steam.

Employing as the starting material rice uncooked rice having a water content of 9% to 13%, where, for example, the gelatinized layer that forms on the grain surface layer during treatment with pressurized heated steam is formed to a thin layer of about 0.3 mm, and a state of minimal porosity is observed in the center, less rice-cooking liquid can be packed into the container together with the grains; and by setting a shorter time period for immersion and absorption subsequent to packing and sealing into the container, rice of a texture having minimal stickiness can be manufactured efficiently.

On the other hand, employing as the starting material rice a rice of water content of 9 to 13%, where, for example, the gelatinized layer that forms on the grain surface layer during treatment with pressurized heated steam is formed to a thick layer of about 0.8 mm, and a state of abundant porosity is observed at the center, the amount of rice-cooking liquid packed into the container together with the grains can be increased as compared with the case of manufacture of rice having a texture with minimal stickiness; and by setting a somewhat longer time period for immersion and absorption subsequent to packing and sealing into the container, rice of a sticky texture can be manufactured efficiently.

In the method for manufacturing retort rice of the present invention, by subjecting the sealed container to immersion and flipping/absorption for 20 to 40 minutes, uniform absorption and permeation of the rice-cooking liquid into the grains can be brought about, in an amount appropriate for the type of rice.

In the method for manufacturing retort rice of the present invention, by flipping the container from several times to between 10 and 20 times during immersion and flipping/absorption, the rice-cooking liquid can be made to be evenly absorbed into and permeate the grains. Moreover, by warming the container using hot air at 60 to 80° C., the time needed for the rice-cooking liquid to be absorbed and permeate can be shortened, and it will be possible to raise the temperature of the center of the grains to the predetermined temperature sooner during retort sterilization.

In the method for manufacturing retort rice of the present invention, by employing a pouch as the container, and ensuring headspace of from 45 to 70% so that the contents can move and flip inside the pouch during the immersion and absorption, uniform absorption and permeation into the starting material rice and into solids inside the pouch can be accelerated.

The retort rice of the present invention has a texture appropriate to the type of rice, the depth of gelatinization and the degree of wetness of the rice cooked as a result of retort sterilization being adjusted through the state of absorption by the grains in the container, and the amount of rice-cooking liquid remaining in the container without being absorbed into the grains.

### BRIEF DESCRIPTION OF DRAWINGS

FIG. 1 is a flow chart of retort rice manufacturing steps in an embodiment of the present invention.

FIG. 2 is an exterior photograph of a grain prior to treatment with pressurized heated steam.

FIG. 3 is an exterior photograph of a grain subsequent to treatment with pressurized heated steam.

FIG. 4 is a cross sectional photograph of a grain prior to treatment with pressurized heated steam.

FIG. 5 is an enlarged photograph of the center of the cross section of the grain shown in FIG. 4.

FIG. 6 is a cross sectional photograph of a grain subsequent to treatment with pressurized heated steam.

FIG. 7 is an enlarged photograph of the center of the cross section of the grain shown in FIG. 6.

FIG. 8 is a graph showing the relationship of grain immersion time of grains in immersion water, and water content of the grains, when treated with pressurized heated steam and when untreated.

### DESCRIPTION OF EMBODIMENTS

The embodiments of the present invention will be described.

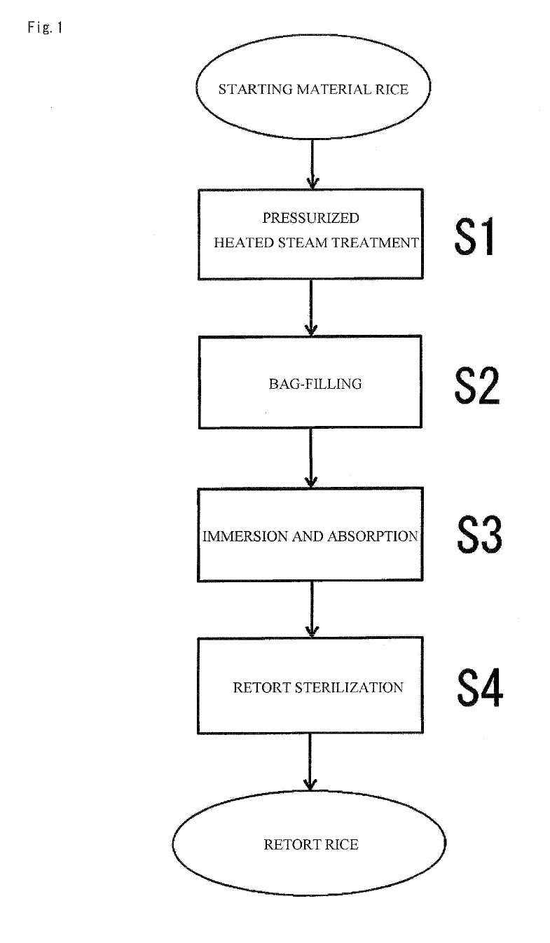

FIG. 1 is a flow chart of retort rice manufacturing steps in an embodiment of the present invention.

The retort rice in the embodiment of the present invention is manufactured by being passed through several steps, namely, a pressurized heated steam treatment step (S1); a bag-filling step (S2); an immersion and absorption step (S3); and a retort sterilization step (S4).

### (1) Starting Material Rice

In the present invention, any type from among japonica rice (short grain type, Japanese style), indica rice (long grain type, Indian style), and javanica rice (large grain type, Java style) can be employed as the starting material rice. As the starting material rice it is preferable to use pre-washed rice or humidifying polished rice, but ordinary white rice may be used as well. The water content of the starting material rice employed will be no greater than normal; i.e., less than 15%, preferably from 9 to 14%, more preferably from 9 to 13%, and even more preferably from 11 to 12%.

Herein, pre-washed rice refers to rice obtained by adding 15% or less of moisture or a rice bran-removing sticky substance to white rice, polishing the surface of the white rice, and removing any bran remaining in microscopic grooves on the surface. Humidifying polished rice refers to rice obtained by polishing of rice with the addition of 1% or less of water, and eliminating most of the bran remaining in the white rice. The use of pre-washed rice or humidifying polished rice obviates the need for sewage treatment equipment to treat wastewater generated by washing of rice.

### (2) Pressurized Heated Steam Treatment Step (S1)

Next, employing a pressure heating chamber (steam circulating type cooking and sterilization device 100-1B made by BIOCON (JAPAN) LTD.), the starting material rice is treated for 1 to 5 minutes under pressurized heated steam at a pressure of 0.07 to 0.38 MPa and temperature of 115 to 150° C.

Through this process, only a surface layer from 0.3 to 0.8 mm from the surface of the starting material rice becomes gelatinized, while at the center, microscopic cracks arise, and a porous form is observed. In a case in which the water content of the starting material rice is 15% or above, the grains become gelatinized into proximity to the center, making it difficult for the center to take on a porous state as described above.

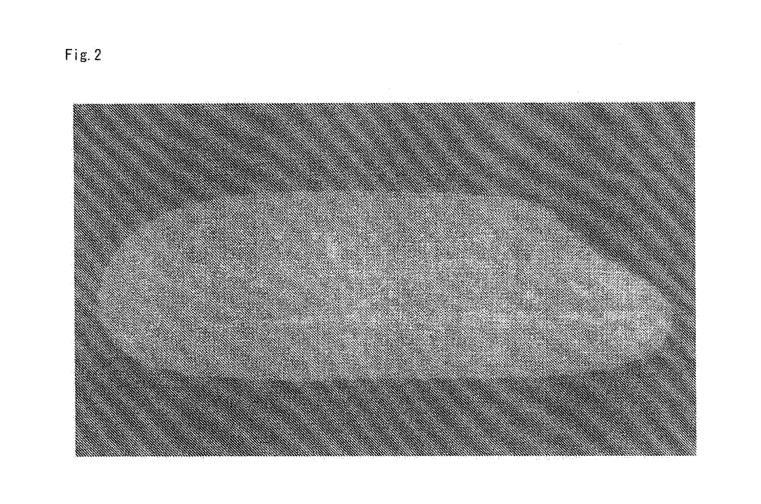

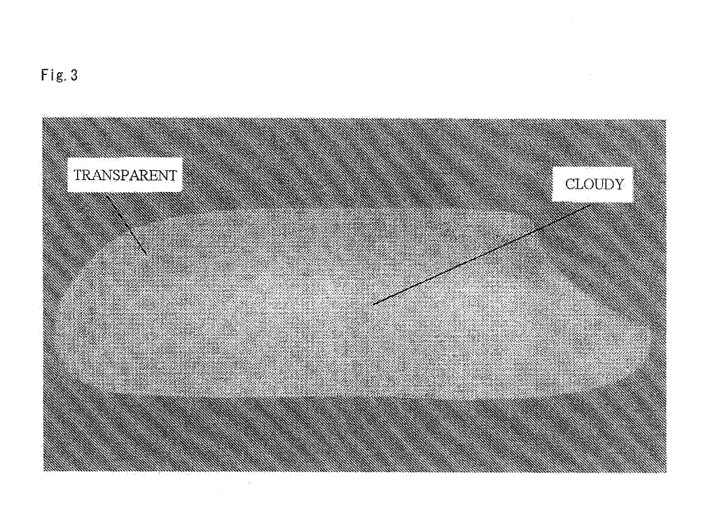

Herein, FIG. 2 is an exterior photograph of an example of grain prior to treatment with pressurized heated steam; and FIG. 3 is an exterior photograph of an example of a grain subsequent to treatment with pressurized heated steam, respectively.

From a comparison of the two, it may be appreciated that subsequent to treatment of the grain, the surface layer is transparent, while the center is cloudy.

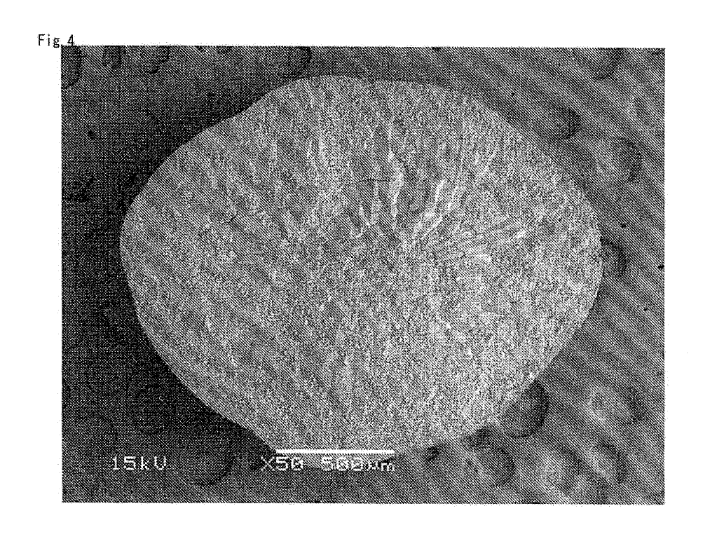

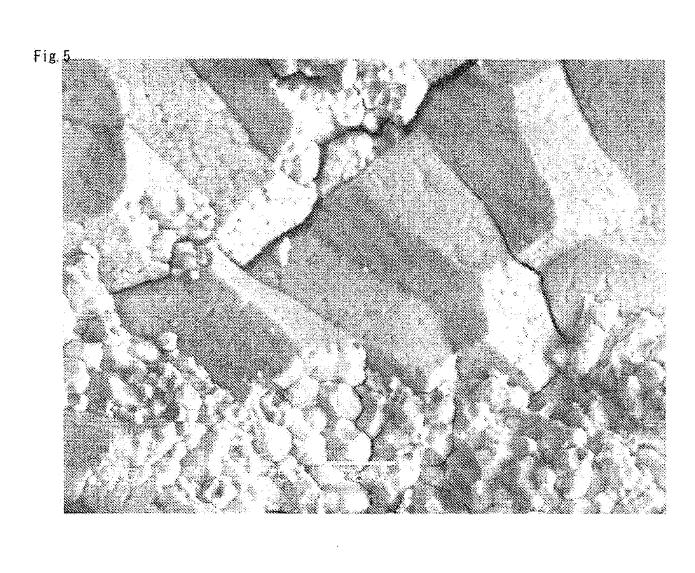

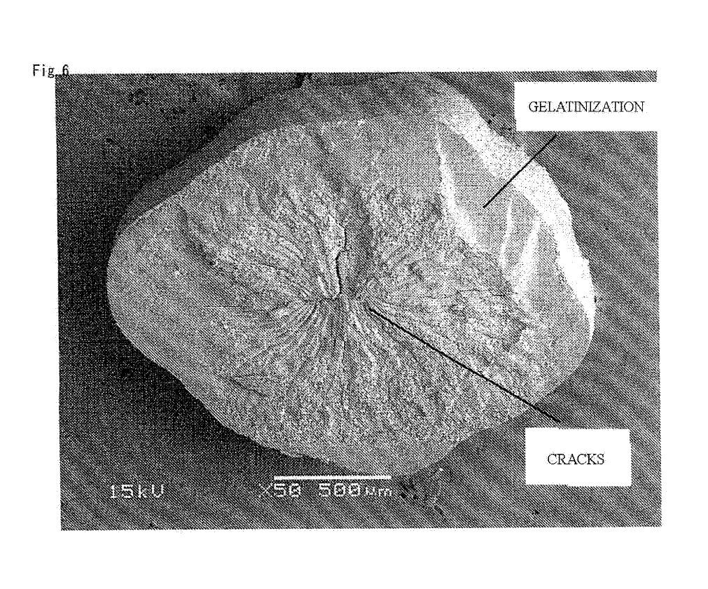

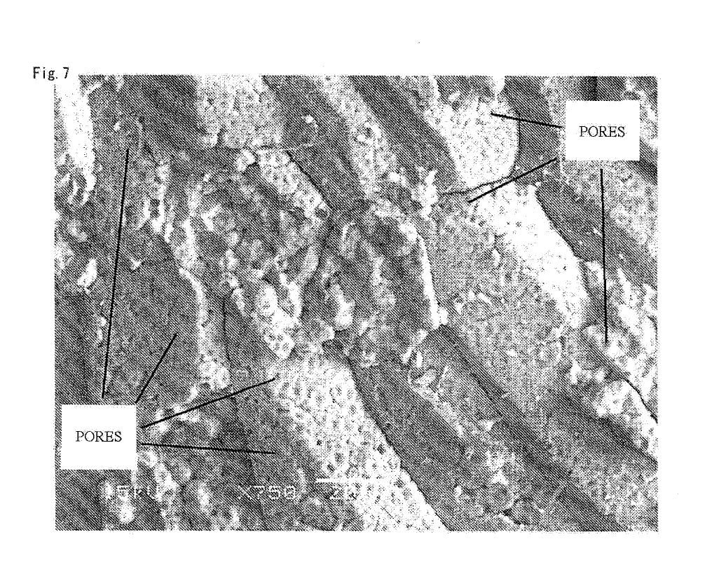

FIG. 4 is an example of a grain prior to treatment with pressurized heated steam, and shows a photograph (at 50× magnification) of the cross section thereof taken with a microscope (JSM-6461 by JEOL Ltd. DATUM); and FIG. 5 is an enlarged photograph (at 750× magnification) of the center of the cross section of the grain shown in FIG. 4, taken with a microscope (JSM-6461 by JEOL Ltd. DATUM). FIG. 6 is an example of a grain subsequent to treatment with pressurized heated steam, and shows a photograph (at 50× magnification) of the cross section thereof taken with a microscope (JSM-6461 by JEOL Ltd. DATUM); and FIG. 7 is an enlarged photograph (at 750× magnification) of the center of the cross section of the grain shown in FIG. 6, taken with a microscope (JSM-6461 by JEOL Ltd. DATUM), respectively.

From a comparison of FIG. 4 and FIG. 6, it may be appreciated that prior to treatment with pressurized heated steam, there is no great difference in appearance between the surface layer and the center of the grains, whereas subsequent to treatment, the surface layer is gelatinized (becomes gelatinous), while at the center, microscopic cracks in a radial pattern have arisen. The features of the cross section of the grains subsequent to treatment match the features of the exterior photograph of the grain shown in FIG. 3, in which the surface layer is transparent and the center is cloudy. From a comparison of FIG. 5 and FIG. 7 it may be appreciated that in the grain subsequent to treatment, a porous state is observed at the center.

The present invention uses a starting material rice of lower water content than normal, does not involve washing or immersion, and the increase in the water content resulting from treatment with pressurized heated steam is no more than 4 to 6%; therefore, the grains do not aggregate subsequent to treatment. Even when clumping does occur, it can be easily separated into individual grains by a separating device. Consequently, in the subsequent bag-filling step (S2), the starting material rice is easily weighed during packing, which provides advantages in terms of implementing the production steps on an assembly line.

### (3) Bag-Filling Step (S2)

Next, a weighing/packaging device is employed to weigh out the starting material rice that has passed through the aforementioned pressurized heated steam treatment step (S1), and is packed into a retort pouch of bag form. At this time, depending on the type of rice, solids such as solid ingredients, and liquids such as water or seasoning liquid, may be packed together into the pouch, mixed with the starting material rice, and sealed therein. By bringing the liquids to a temperature of 60 to 80° C., absorption and permeation thereof into the starting material rice and the solids is accelerated.

In this step, the order of packing the aforementioned packed materials into the retort pouch can be selected freely, with the object of bringing about uniform absorption and permeation of liquid into the starting material rice and the solids.

Moreover, in order to accelerate uniform absorption and permeation into the starting material rice and into the solids inside the sealed retort pouch, it is necessary to ensure headspace of 45 to 70%, preferably about 60%, so that the contents can move and flip during the subsequent immersion and absorption step (S3). Due to the high air content of the headspace, it is preferable to replace the air with an inert gas such as nitrogen gas or the like, to prevent oxidation of the product.

In consideration of the rate of absorption and the amount of absorption in the subsequent immersion and absorption step (S3), the starting material rice is preferably not passed through a cooling step subsequent to treatment with pressurized heated steam, but is instead quickly packed into the retort pouch while maintained in a high-temperature state.

### (4) Immersion and Absorption Step (S3)

The starting material rice, having been packed into a retort pouch in the aforementioned bag-filling step (S2) and immersed in liquid inside the pouch, absorbs the liquid all at once over a period of about 10 minutes. Thereafter, tempering is performed over a period of about 10 to 30 minutes more, until the starting material rice has reached a saturation absorption state or a predetermined absorption state, during which time the pouch may be flipped several times to between 10 and 20 times, and preferably flipped about four to six times, to bring about uniform absorption and permeation of liquid into the starting material rice and solids with no unevenness. As the flipping means, the pouch, transported on a belt that is arranged horizontally in multiple tiers, may be successively flipped and dropped onto lower tiers of the belt.

In this step, by warming the retort pouch to 60 to 80° C. with hot air, the aforementioned tempering time can be shortened further, making it possible to raise the temperature of the center of the grains to the predetermined temperature sooner during the subsequent retort sterilization step (S4).

As a preliminary step to the immersion and absorption step (S3), by furnishing a step in which the retort pouch undergoes heat treatment for 1 to 5 minutes while being bombarded continuously or intermittently with normal-pressure microwaves, the temperature of the center of the grains rises and the center swells, as a result of which it is possible to bring about absorption and permeation of liquid into the starting material rice in an even shorter time period. Adopting a step of continuous bombardment with normal-pressure microwaves provides advantages in terms of implementing the production steps on an assembly line.

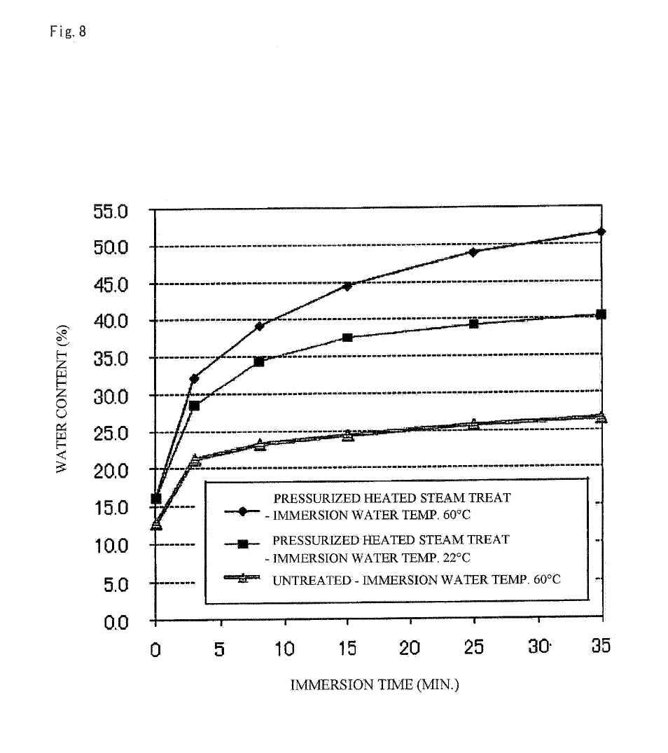

FIG. 8 is a graph of the relationship of grain immersion time of grains in immersion water, and water content of the grains, when treated with pressurized heated steam versus when untreated.

Grains of long grain type with a water content of 12.7% (Puntal rice from Spain) was employed as the grains. Treatment by pressurized heated steam was performed in a retort chamber (steam circulating type cooking and sterilization device 100-1B made by BIOCON (JAPAN) LTD.) for 5 minutes under pressurized heated steam at a pressure of 0.18 MPa and temperature of 130° C. The treated grains were then immediately immersed in water at 60° C. or 22° C., while also immersing untreated grains in 60° C. water, and measuring the water content of the different grains over time.

From FIG. 8, it may be appreciated that the grains that underwent treatment with pressurized heated steam had a faster rate of absorption than did the untreated grains, and that there was a marked increase in the amount of absorption as well. As shown in FIG. 7, in the grains that underwent treatment with pressurized heated steam, the center was observed to have a porous state, and therefore it is thought that water passing through the gelatinized layer formed on the surface layer would be efficiently absorbed and permeate in large amounts into the porous center within a short time period.

Also, from FIG. 8, it may be appreciated that the grains that underwent treatment with pressurized heated steam exhibited a faster rate of absorption, and the amount of absorption increased as well, with higher temperature of the water in which they are immersed.

### (5) Retort Sterilization Step (S4)

In accordance with normal methods, in the retort sterilization step, heat treatment is performed at heat treatment conditions of the equivalent of 4 minutes in a state with the center of the food at a temperature of 120° C.; however, heat treatment may also be performed under conditions having equal or greater efficacy, for example, for about 35 minutes in a state with the center of the food at a temperature of 115° C.

In this step, due to the rise to the aforementioned predetermined temperature in the center of grains, the grains, having reached a predetermined state of absorption in the immersion and absorption step (S3), gelatinize to their center. At this time, the depth of the aforementioned gelatinization will differ depending on the aforementioned state of absorption of the grains. In a case in which the grains are in a state of saturation absorption, the grains will completely gelatinize to the center.

### (6) Retort Rice

The inventors arrived at the manufacturing method comprising the aforementioned steps (S1) to (S4) upon making the novel discovery that through treatment by the aforementioned pressurized heated steam treatment step (S1), for a starting material rice that has a water content of no more than normal, a porous state is observed at the center, and the rate of absorption is thereby faster, and the amount of absorption is markedly increased; and, having uncovered this behavior, performed painstaking research focused on this behavior.

According to the method far manufacturing retort rice in the embodiment of the present invention comprising the aforementioned steps (S1) to (S4), adjusting the amount of solids such as solid ingredients and liquids such as water or seasoning liquid packed into the retort pouch in the aforementioned bag-filling step (S2), and adjusting the state of absorption of the grains inside the pouch as well as the amount of liquid remaining in the pouch without being absorbed into the grains by adjusting the tempering time in the aforementioned immersion and absorption step (S3) or other parameters makes it possible to adjust the depth of gelatinization and the degree of wetness of the rice cooked as a result of the aforementioned retort sterilization step (S4), and to adjust the texture of the rice without restriction.

Consequently, according to the method for manufacturing retort rice in the embodiment of the present invention, rice that has grainy texture and stickiness, and a soft inside and firm outside, and that has completely gelatinized to the core (rice having stickiness), or rice having a texture of minimal stickiness (al dente rice) can be manufactured, making it possible to manufacture various types of rice such as steamed rice, porridge, soupy rice, rice with five ingredients, rice with assorted ingredients, curry, gukbap, pilaf, fried rice, paella, risotto, and the like.

In particular, according to the method for manufacturing retort rice in the embodiment of the present invention, rice that is stickier than conventional long grain types can be manufactured, even in the case of a starting material rice of long grain type and low water content, of the sort primarily used in the manufacture of rice with a texture of minimal stickiness.

By the method for manufacturing retort rice in the embodiment of the present invention, through appropriate setting of the various parameters of pressure, temperature, and treatment time during treatment of uncooked rice by pressurized heated steam, the thickness of the gelatinized layer that forms on the grain surface layer, and the porous state that appears at the grain center, can be adjusted.

Employing as the starting material rice uncooked rice having a no more than approximately a normal water content; i.e., less than 15%, and preferably from 9 to 13%, where for example the gelatinized layer that forms on the grain surface layer during treatment with pressurized heated steam is formed to a thin layer of about 0.3 mm, and a state of minimal porosity is observed in the center, less liquid can be packed into the container together with the grains; and by setting a shorter time period for immersion and absorption subsequent to packing and sealing into the container, rice of a texture having minimal stickiness can be manufactured efficiently.

On the other hand, employing as the starting material rice uncooked rice having water content of about normal, or less than normal, i.e., less than 15%, and preferably from 9 to 13%, where, for example, the gelatinized layer that forms on the grain surface layer during treatment with pressurized heated steam is formed to a thick layer of about 0.8 mm, and abundant porosity is observed in the center, the amount of liquid packed into the container together with the grains can be greater than when manufacturing rice having a texture with minimal stickiness; and by setting a somewhat longer time period for immersion and absorption subsequent to packing and sealing into the container, rice having stickiness can be manufactured efficiently.

### EXAMPLE 1

In order to obtain paella-type retort rice (al dente rice) containing 55% water per 500 g, employing 178 g of pre-washed rice of long grain type having 12% water content (Puntal rice from Spain), the pre-washed rice was treated with pressurized heated steam in a retort chamber (steam circulating type cooking and sterilization device 100-1B made by BIOCON (JAPAN) LTD.) for 2 minutes at a pressure of 0.14 MPa and temperature of 125° C.

Next, the treated pre-washed rice, 96 g of 60° C. water, and 226 g of a 60° C. seasoning liquid containing 68 g of solids such as squid and shrimp, were packed and sealed into a retort pouch, while ensuring headspace of 60%.

Further, tempering was performed for 25 minutes to make the water and seasoning liquid absorb into and permeate the pre-washed rice and the solids, flipping five times during the process.

Finally, using standard methods to perform retort sterilization, the product was raised in temperature over a 22 minute period and heated for 35 minutes with the center at 115° C., then lowered in temperature over a 15 minute period, to obtain paella style retort rice.

When the pouch was unsealed and the rice sampled, it was confirmed that paella rice having a texture with minimal stickiness had been successfully manufactured.

### EXAMPLE 2

In order to obtain white retort pouch rice (rice having stickiness) containing 62% water per 500 g, employing 218 g of pre-washed rice of long grain type having 13% water content (Puntal rice from Spain), the pre-washed rice was treated with pressurized heated steam in a retort chamber (steam circulating type cooking and sterilization device 100-1B made by BIOCON (JAPAN) LTD.) for 3 minutes at a pressure of 0.18 MPa and temperature of 130° C.

Next, the treated pre-washed rice and 282 g of 80° C. water were packed and sealed into a retort pouch, while ensuring headspace of 60%.

Further, tempering was performed for 35 minutes to make the water absorb into and permeate the pre-washed rice, flipping five times during the process.

Finally, using standard methods to perform retort sterilization, the product was raised in temperature over a 22 minute period and heated for 35 minutes with the center at 115° C., then lowered in temperature over a 15 minute period, to obtain white retort rice.

When the pouch was unsealed and the rice sampled, it was confirmed that rice soft inside and firm outside, and having stickiness, had been obtained.

The method of manufacturing retort rice in the aforementioned embodiment of the present invention involved packing into a retort pouch the starting material rice having undergone treatment by a pressurized heated steam treatment step; however, retort rice can be manufactured analogously in cases of packing into other heat-resistant containers as well.

According to the method of manufacturing retort rice of the present invention, uncooked rice having a water content of no more than normal; i.e., less than 15%, preferably from 9 to 14%, more preferably from 9 to 13%, and even more preferably from 11 to 12%, is treated with pressurized heated steam to form a thin gelatinized layer on the surface layer of the grain as well as to produce a porous center, and therefore the rate of absorption and permeation of liquid into the starting material rice after being packed and sealed in a container is faster, and the amount of absorption is increased as well. Therefore, the grains inside the container can absorb a sufficient amount of liquid during tempering for a shorter time as compared with the prior art. In cases of manufacture of ordinary rice, i.e., not rice having wetness such as porridge, soupy rice, or the like, there will be sufficient absorption even with a short tempering time, and during retort sterilization the grains inside the container are not submerged in liquid, and therefore no starch will dissolve out from the grains, so that the cooked rice does not become starchy. Moreover, because the uncooked rice having no more than approximately a normal water content; i.e., less than 15%, is treated with pressurized heated steam without being first immersed in water, the rice grains do not aggregate after treatment, and are easily measured during packing into the container. As a result, the pretreatment time leading up to the retort sterilization process can be shortened and production efficiency improved, and implementation of the production steps on an assembly line is possible as well.

The present invention is not limited by the aforementioned embodiment, and the configuration can be appropriately modified within the scope of the invention.

### INDUSTRIAL APPLICABILITY

The method for manufacturing retort rice of the present invention shortens the pretreatment time leading up to the retort sterilization process and improves production efficiency, as well as making possible implementation of the production steps on an assembly line, and has exceedingly high value in application.

1. A method for manufacturing retort rice, comprising the steps of:
forming a thin gelatinized layer on the surface layer of individual rice grains and making the center of each of the grains porous by treating uncooked rice with pressurized heated steam;
immediately packing and sealing said rice grains inside a container together with a predetermined amount of a rice-cooking liquid without passing the grains through a cooling step;
adjusting the state of absorption of said rice grains and the amount of rice-cooking liquid in the container by immersing said rice grains in the rice-cooking liquid and allowing the grains to absorb the liquid; and
performing retort sterilization.

2. The method for manufacturing retort rice according to claim 1, wherein said uncooked rice having a water content of from 9% to 13% is treated with pressurized heated steam for 1 to 5 minutes at a pressure of 0.07 to 0.38 MPa and a temperature of 115 to 150° C., and a gelatinized layer of 0.3 to 0.8 mm is formed on the surface layer of each of the rice grains.

3. The method for manufacturing retort rice according to claim 2, wherein said sealed container is subjected to immersion and flipping/absorption for 20 to 40 minutes.

4. The method for manufacturing retort rice according to claim 3, wherein during said immersion and absorption, said container is flipped from several times to between 10 and 20 times, and said container is warmed by hot air at 60 to 80° C.

5. The method for manufacturing retort rice according to claim 4, wherein said container is a pouch; and headspace of from 45 to 70% is ensured so that the contents can move and flip inside said pouch during said immersion and absorption.

6. Retort rice produced by a process comprising the steps of:
forming a thin gelatinized layer on the surface layer of individual rice grains and making the center of each of the grains porous by treating uncooked rice with pressurized heated steam;
immediately packing and sealing said rice grains inside a container together with a predetermined amount of a rice-cooking liquid without cooling the grains; and
adjusting the depth of gelatinization and the degree of wetness of the rice cooked by retort sterilization according to the state of absorption of said rice grains and the amount of rice-cooking liquid in the container by immersing said rice grains in the rice-cooking liquid and allowing the grains to absorb the liquid.
